(19) United States
(12) Patent Application Publication
(10) Pub. No.: US 2009/0160718 A1
(43) Pub. Date: Jun. 25, 2009

(54) PLANE FOCUS ANTENNA

(76) Inventors: Ta-Jen YEN, Hsinchu County (CN); Cheng-Kuang Chen, Taichung City (CN)

Correspondence Address: Joe McKinney Muncy, PO Box 1364, Fairfax, VA, 22038-1364, US

(21) Appl. No.: 11/963,583

(22) Filed: Dec. 21, 2007

(51) Int. Cl. H01Q 7/00; H01Q 11/12

(52) U.S. Cl. 343/742

(57) ABSTRACT

A plane focus antenna includes a plurality of stacking substrates. Each substrate has one side formed a periodic array plane consisting of a plurality of resonant coils and other side laid a metal wire formed in a periodic structure. The magnetic permeability of the stacking double split-ring resonators is negative and the electric permittivity of the metal wire is negative at the same time that can interact with electromagnetic waves to fabricate a negative refractive index material (NRIM) to form the plane focus antenna. By means of the special refractive effect of the NRIM receiving signals can be converged in a very small area to enhance the receiving signals. The plane antenna also does not generate distortion.

### FIELD OF THE INVENTION

The present invention relates to a plane focus antenna and particularly to a high frequency plane focus antenna made from a negative refractive index material (NRIM) and adopted Snell's law to change incident wave traveling direction to focus the incident wave at a smaller area to form a stronger receiving signal without distortion.

### BACKGROUND OF THE INVENTION

The rapid advance of wireless communication industry has constantly spawned a wide variety of communication products. Competition is intense. These days the communication products have to be versatile, provide multiple functions and be lean and light. To meet these requirements, demand on antenna also is very high. In 1994 plane focus antenna was announced that is a meandering radiation object formed on a substrate. Such a structure can effectively shrink the length and size of the antenna.

Aside from smaller size, the antenna also has to support multiple frequencies and cover a wide range of bandwidths, such as wireless mobile communication system frequencies EGSM (880-960 MHz), DCS (1710-1880 MHz), PCS (1850-1990 MHz) and WCDMA/CDMA2000 (1920-2170 MHz). These frequency ranges can be divided into a first operational frequency (880-960 MHz) at a bandwidth of 80 MHz and a second operational frequency (1710-2170 MHz) at a bandwidth of 460 MHz.

However, the conventional antenna at the high frequency of the second operational frequency (1710-2170 MHz) has an effective bandwidth of merely 280 MH. Namely there is still expandability not yet being filled on the operational bandwidth at the high frequency for the present antenna.

Moreover, in terms of installation locations, the antenna used on the wireless communication products generally can be divided into external connection and build-in types. The external connection type that adopts the helical antenna mostly is formed in a circular shape. If a plane antenna is adopted, its profile is versatile and can be easily formed in various shapes such as rectangle, square, ellipse and the like.

Moreover, chip type antenna can be easier fabricated through the plane structure by mounting onto a circuit board through the surface mounted technology (SMT). This method can greatly reduce the cost of packaging and connection, thus is more suitable to be coupled with other objects without affecting the profile and characteristics of the objects.

In addition, in terms of the plane antenna structure, the conventional techniques cannot achieve the effect of converging signals. This is because most of the dielectric materials have a positive refractive index. The refractive index is very important to the permeability of electromagnetic wave. The refractive index is formed by skewing caused by interactions of electromagnetic wave and electric permittivity and magnetism. Hence in order to reduce distortion there is a constraint for the size of the antenna to receive high frequency communication.

### SUMMARY OF THE INVENTION

Therefore the primary object of the present invention is to provide a plane focus antenna formed by stacking a plurality of substrates. Each of the substrates has one side formed a periodic array plane consisting of a plurality of resonant coils and other side laid with a metal wire formed in a periodic structure. The substrates are made from ceramic or glass fibers. The resonant coils are double split-ring resonators made of non-magnetic conductive metal such as gold, silver, copper or aluminum. The metal wire is made from gold, silver, cooper or aluminum.

By means of the construction set forth above, and through the characteristics of the stacking double split-ring resonator of negative magnetic permeability and the metal wire which has negative electric permittivity, a NRIM can be formed by stacking. Such a material can be used to fabricate a plane focus antenna. NRIM has focus effect like a convex lens. Through the plane focus antenna signals can be converged to a very small area to enhance signal receiving. Moreover, because of the antenna is a plane distortion can be prevented. Because of these features the plane focus antenna of the invention can be made in a small size and light weight.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the structure of the plane focus antenna of the invention.

FIG. 2 is a schematic view of the structure of one substrate of the invention.

FIG. 3 is a schematic view of the light converging effect of a convex lens.

FIG. 4 is a schematic view of signal converging effect and image forming through signals of a negative refractive index material (NRIM).

FIG. 5 is a chart showing the measurement of the S-parameter magnitude of the invention.

### DETAILED DESCRIPTION OF THE PREFERRED EMBODIMENT

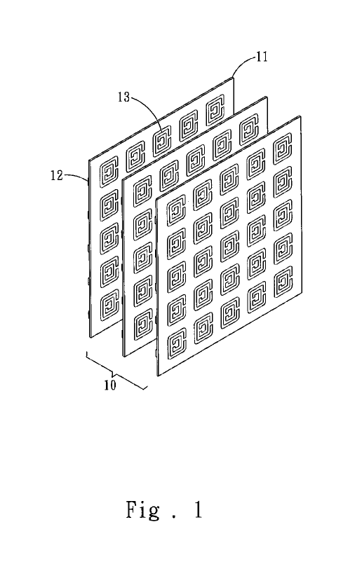

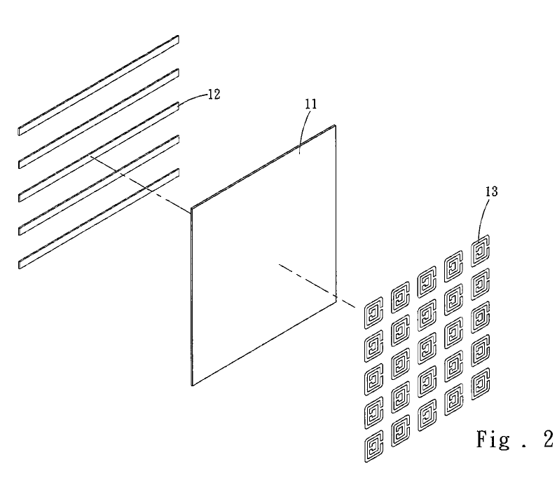

Please refer to FIGS. 1 and 2, the plane focus antenna 10 according to the invention is formed by stacking a plurality of substrates 11 together. Each of the substrates 11 has one side formed a periodic array plane consisting of a plurality of resonant coils 13 and other side laid with a fine metal wire formed in a periodic structure. The substrates 11 are made from ceramic or glass fibers. The resonant coils 13 are double split-ring resonators made of non-magnetic conductive metal such as gold, silver, copper or aluminum. The fine metal wire 12 is made of metal of a negative electric permittivity and is selected from gold, silver or aluminum.

Refractive index is very important to the permeability of electromagnetic wave. The refractive index is formed by skewing caused by interactions of electromagnetic wave and electric permittivity and magnetic permeability. However the medium of negative refractive index does not exist in the nature. There is no material in the nature that can form a negative refractive index as there is no material in the nature that has electric permittivity and magnetic permeability smaller than zero at the same time.

However there is a man-made material called meta-material which has negative magnetic permeability. The meta-material is a man-made composite structure arranged in a regular fashion. By controlling the arrangement and material composition the effect of electromagnetic wave in the material can be maneuvered. Hence through the meta-material many characteristics not exist in the natural material can be achieved, such as the negative refractive index material.

Based on the definition of the magnetic dipole moment (m), the following equation can be derived:

$$m = \frac{1}{2} {\int }_{V} r \times j d V$$

where r is the radius of a coil and j is current intensity. Under the action of a time-varying magnetic field, when an induced local current flows around a closed coil, a magnetic dipole moment is generated. By bringing the resonance characteristics to the coil, the magnetic dipole moment increases, even a negative magnetic permeability can be obtained, namely the magnetic permeability can be negative.

In 1999 J. B. Pendry proposed a number of man-made magnetic material structures which have a periodic layout consisting of split rings or tubular non-magnetic conductor resonant units like a LC resonator equipped with a capacitor and an inductor. Take a split-ring resonator as an example for the following discussion. As previously discussed, the concept of the split-ring resonator to generate magnetic response is as follow: a time-varying magnetic field induces current on a planar circuit, and the circulating current generates magnetic response. The inductance of the split-ring resonator and the capacitance resulting from the split-ring form resonance to boost the magnetic response. The equivalent magnetic permeabilityμ can be obtained according to the following formula:

$$μ ( ω ) = 1 - \frac{F {ω}^{2}}{{ω}^{2} - {ω}_{0}^{2} + i ω Γ}$$

where F is the geometric factor of the structure, ω₀ is the resonance frequency, and Γ is the resistance loss.

The theory proposed by J. B. Pendry was proved very soon. A magnetic meta-material formed on a glass fiber board was made that generates magnetic response at a frequency band of 10.5 GHz. In short, based on the concept of resonance, to get magnetic response under a higher frequency the resonance frequency has to be raised. In other words, a unit structure of a smaller size and interval has to be fabricated. To do this has to overcome the problem of Ohmic loss at the shrunk size. Thus the double split-ring resonator at the micrometer level can present magnetic response in a wide range of bandwidth. The frequency band capable of generating magnetic response can also be regulated and altered through control of the structural size.

According to the theory of negative refractive index material (NRIM): when the magnetic permeability (μ) and electric permittivity (∈) are negative at the same time, electromagnetic wave traveling in such a material presents transmission characteristics different from the ordinary medium, such as Snell effect. Namely, when an incident light enters the NRIM, the refractive light being generated and the incident light are on the same side of the normal. Other special physical phenomena being generated include inverse Doppler effect and counter rotation of Cherenkov radiation. In 2000 D. R. Smith successfully proved the existence of negative refractive phenomenon through experiments. Through a copper split-ring resonator structure and a copper conductive wire on a glass fiber board he constructed a two dimensional isotropic structure. In order to make this two dimensional structure to be treated as a uniform medium under microwave the unit cell size consisting of the split-ring resonant coil and conductive wire has to be much smaller than the incident wavelength. The split-ring resonant structure aims to generate magnetic reaction through the resonant coil and the magnetic field of electromagnetic wave so that the effective magnetic permeability (μ) can be smaller than zero under a selected frequency. The fine metal wire aims to generate plasma resonance (namely plasma frequency) through the electric field of the electromagnetic wave to make the equivalent electric permittivity (∈) to be smaller than zero when it is smaller than the plasma frequency. According to the previous theory of:

n=±\sqrt{∈μ}

when the effective magnetic permeability (μ) and effective electric permittivity (∈) are both smaller than zero at the same time, the material generates the characteristics of a negative refractive index, namely n=−\sqrt{∈μ}.

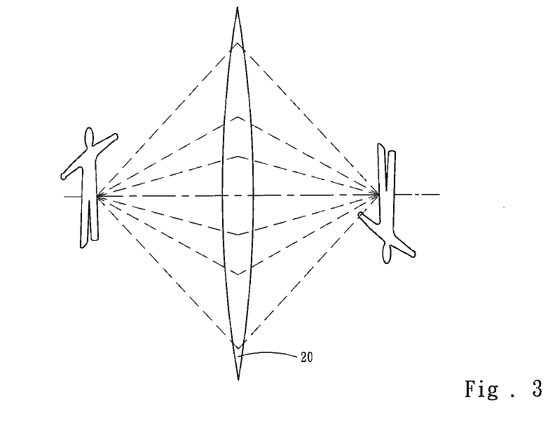

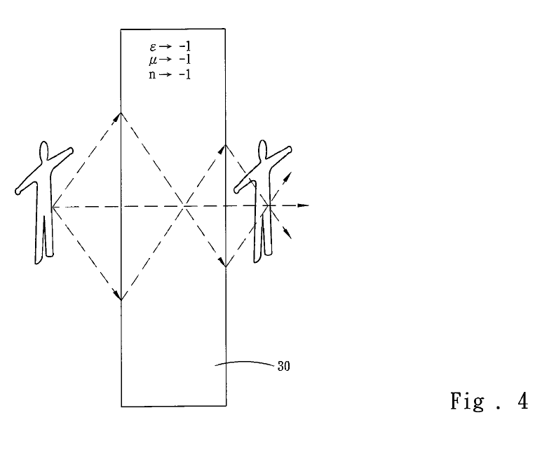

Refer to FIG. 3 for the light converging effect of a convex lens. Incident light passes through a convex lens 20 and bends (refracts) to focus to form an image. Similarly, for a NRIM 30 (referring to FIG. 4), when the effective magnetic permeability (μ) and effective electric permittivity (∈) are both −1, the refractive index of the NRIM 30 is n=−1. In such a condition a plane mirror made from the NRIM 30 can create focus effect like a convex lens. As the mirror is flat there is no image distortion.

As the plane focus antenna 10 of the invention is made from NRIM 30 formed by stacking a plurality of resonant coils 13 and a fine metal wire 12 of a negative electric permittivity, it can generate focus effect like a convex lens so that signals can be converged in a very small area to enhance receiving signals. Moreover, as the unit cell size of each resonant coil 13 of the periodic plane array is much smaller than the electromagnetic wave, it can be treated as an effective uniform medium in terms of the electromagnetic wave. Through this characteristic the material of the invention can generate magnetic response in a wide range of bandwidth, even above THz. The bandwidth capable of generating the magnetic response can also be regulated and altered through control of structural size. Such electromagnetic characteristics can be maneuvered and used in applications related to high frequency magnetism.

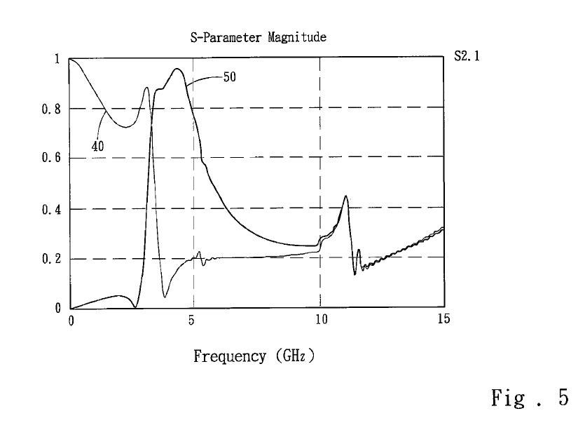

Referring to FIG. 5, measurement of S-parameter magnitude on the plane focus antenna 10 can be done through a CST simulation software. As shown in the chart, the intensity curve 40 of the electromagnetic wave of the plane focus antenna 10 permeates the resonant ring and the electromagnetic wave also permeates at the same time the intensity curve 50 of the resonant coil 13 and fine metal wire 12. This confirms that the plane focus antenna 10 generates the characteristics of NRIM 30 in the high frequency communication bandwidth range of 4 GHz and 5 GHz.

As the plane focus antenna 10 is flat, distortion can be prevented. Moreover, the antenna of the invention is formed at a small size and low cost (by using glass fibers as material) and has desirable characteristics. It also can be fabricated in various types and shapes according to requirements. Through control of the structural size of the resonant coil 13 the bandwidth capable of generating magnetic response can be regulated and altered. By changing the number of layers of the substrates, the resonant frequency and frequency ratio of the antenna can be changed. Hence it can be used in a wide variety of wireless communication systems, and has a significant competitive advantage in the future high frequency antenna market.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A plane focus antenna comprising:
a plurality of substrates stacking together; and
a periodic array plane formed on one side of each of the substrates that consists of a plurality of resonant coils and a fine metal wire formed in a periodic structure on other side of the substrates.

2. The plane focus antenna of claim 1, wherein the substrates are selectively made from ceramic or glass fibers.

3. The plane focus antenna of claim 1, wherein the resonant coils are double split-ring resonators.

4. The plane focus antenna of claim 3, wherein the resonant coils are made of non-magnetic conductive metal.

5. The plane focus antenna of claim 4, wherein the conductive metal is selected from the group consisting of gold, silver, copper and aluminum.

6. The plane focus antenna of claim 1, wherein the fine metal wire is selected from the group consisting of gold, silver, copper and aluminum.
